(19) United States
(12) Patent Application Publication
(10) Pub. No.: US 2008/0192814 A1
(43) Pub. Date: Aug. 14, 2008

(54) System and Method for Physical-Layer Testing of High-Speed Serial Links in their Mission Environments

(75) Inventors: Mohamed M. Hafed, Montreal (CA); Donald Dansereau, Montreal (CA); Geoffrey Duerden, Montreal (CA); Sebastien Laberge, Montreal (CA); Yvon Nazon, Montreal (CA); Clarence Kar Lun Tam, Montreal (CA)

Correspondence Address: DOWNS RACHLIN MARTIN PLLC, 199 MAIN STREET, P O BOX 190, BURLINGTON, VT, 05402-0190, US

(73) Assignee: DFT Microsystems, Inc., Burlington, MA (US)

(21) Appl. No.: 12/028,577

(22) Filed: Feb. 8, 2008

Related U.S. Application Data
(60) Provisional application No. 60/889,085, filed on Feb. 9, 2007.

(51) Int. Cl. H04B 3/46

(52) U.S. Cl. 375/224

(57) ABSTRACT

A physical-layer tester for testing a high-speed serial link between a mission-environment transmitter and a mission-environment receiver. The tester includes a data path and a measurement path. The data path allows a data signal transmitted from the mission-environment transmitter to be passed through the tester to the mission-environment receiver. The measurement path includes circuitry for use in analyzing characteristics of the high-speed serial data traffic on the high-speed serial link. The tester is placed in the high-speed serial link and allows the link to be tested while live, mission-environment data is present on the link. Methods for implementing in-link testing are also disclosed.

### RELATED APPLICATION DATA

This application claims the benefit of priority of U.S. Provisional Patent Application Ser. No. 60/889,085, filed Feb. 9, 2007, and titled “Physical-Layer Testing Of Live In-System High-Speed Serial Links,” which is incorporated by reference herein in its entirety.

### FIELD OF THE INVENTION

The present invention generally relates to the field of testing high-speed serial links. In particular, the present invention is directed to a system and method for physical-layer testing of high-speed serial links in their mission environments.

### BACKGROUND

Modern chip-to-chip, board-to-board, and system-to-system buses deploy advanced packet-based data transfer technologies that borrow many principles from the communications industry. These buses are called “high-speed serial links.” They constitute advanced communications channels that elicit multiple layers of processing and are capable of, among other things, tolerating transmission errors. Multiple serial links are often grouped together to constitute a high-speed bus. Such serial buses are used in a variety of settings, such as the bus between a microprocessor and a graphics processor in a desktop computer application. An example of a currently popular high-speed serial bus standard in the desktop computer realm is the peripheral component interconnect (PCI) standard known as “PCI Express.” Most chip-to-chip and board-to-board interfaces are soon going to migrate to high-speed serial links because of their error tolerance, throughput advantages, and wiring efficiencies.

Because of the multiple layers of processing needed, serial bus interfaces are sophisticated systems that pose significant design and debug challenges at various levels of abstraction; physical, logical, and software layers all interplay to achieve the large throughput and reliability. At the semiconductor device level, designers have at their disposal various tools to debug and characterize high-speed serial bus interfaces, especially the physical layer (PHY). At high data-transfer rates, the physical layer is analog in nature, with parameters such as signal shape, jitter, and noise all being important. Instruments such as oscilloscopes, pattern generators, clock generators, jitter analyzers, and bit-error-rate testers are thus required for debugging the physical layer. In the current state of the art, physical-layer testing is performed in complete isolation from the mission-environment behavior of the bus. This is to say that artificial input/output conditions are often used to characterize a physical layer in order to estimate/predict how it would operate when coupled with the higher layers in a fully-assembled serial-bus architecture. Logic and protocol analysis is often performed on a system once it is fully assembled.

Because of the complexity (non-determinism) of higher-level layers in a serial bus, conventional physical-layer test instruments rapidly become ineffective once a complete board or a system needs to be debugged and characterized. For example, most PHY instruments require repetitive, deterministic data patterns to operate correctly, whereas live traffic is neither repetitive nor deterministic. Other limitations hinder the deployment of such instruments in the test of complete links (multiple lanes) or systems. To name a few limitations, the bench instruments needed are costly, they often do not have a large enough number of test channels, they often require the device under test to operate in artificial test modes (using deterministic stimulus), and they do not measure what an actual receiver on a board will “see.” Most importantly, present-day test instruments invariably require secondary interconnection paths through cables or similar connection mechanisms for the high-speed signals being measured.

### SUMMARY OF THE DISCLOSURE

One implementation of the present invention is a system for testing a high-speed serial link. The system includes: a physical-layer tester configured to be inserted into a high-speed serial link between a mission-environment transmitter and a mission-environment receiver, the physical-layer tester comprising: a tester receiver for receiving high-speed serial data from the mission-environment transmitter; a tester transmitter for transmitting the high-speed serial data to the mission-environment receiver; a data path extending between the tester receiver and the tester transmitter so as to carry the high-speed serial data from the tester receiver to the tester transmitter without loss; and a measurement path in communication with the tester receiver for receiving the high-speed serial data, the measurement path including measurement circuitry for measuring characteristics of the high-speed serial data.

Another implementation of the present invention is a method of testing a high-speed serial link between a mission-environment transmitter and a mission-environment receiver. The method includes: receiving high-speed serial data signal from a mission-environment transmitter; transmitting the received high-speed serial data signal to a mission-environment receiver corresponding to the mission-environment transmitter; substantially simultaneously with the transmitting of the received high-speed serial signal, digitizing the received high-speed serial signal to generate a first digitized signal; and analyzing the first digitized signal

Still another implementation of the present invention is a method of testing a high-speed serial link between a mission-environment transmitter and a mission-environment receiver. The method includes: providing a physical-layer tester that includes: a high-speed data input for receiving high-speed serial data output by a mission-environment transmitter; a high-speed data output for providing the high-speed serial data to a mission-environment receiver; a data path extending between the high-speed data input and the high-speed data output for carrying the high-speed serial data from the high-speed data input to the high-speed data output without loss; and a measurement path, in communication with the high-speed data input, for use in determining characteristics of the high-speed serial data; placing the high-speed data input into communication with a first device having a mission-environment transmitter; placing the high-speed data output into communication with a second device having a mission-environment receiver corresponding to the mission-environment transmitter; and conducting testing of the high-speed serial link between the mission-environment transmitter and the mission-environment receiver.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a high-level schematic diagram of a test setup made in accordance with concepts of the present invention and that includes a mission-deployed physical-layer tester coupled between a high-speed transmitter and a high-speed receiver;

FIG. 2 is a schematic diagram illustrating the architecture of a typical high-speed serial link of the prior art;

FIG. 3 is a diagram of a prior art equivalent mathematical model for the jitter behavior of the high-speed serial link of FIG. 2 as defined by the PCI Express standard;

FIG. 4 is a high-level schematic diagram of a physical-layer tester suitable for use in the test setup of FIG. 1;

FIG. 5 is a high-level schematic diagram of an alternative physical-layer tester suitable for use in the test setup of FIG. 1 and that includes a linear equalizer of each channel for amplifying very high-speed data signals;

FIG. 6 is a high-level schematic diagram of another alternative physical-layer tester suitable for use in the test setup of FIG. 1 and that includes a time-base generator for digitizing the incoming data signal;

FIG. 7 is an exemplary eye diagram illustrating that the time-base generator of FIG. 6 is able to sample the incoming data signal anywhere in the eye;

FIG. 8 is an exemplary bathtub curve constructed using the physical-layer tester of FIG. 6 installed in a mission-environment PCI Express application;

FIG. 9 is an exemplary bit error rate contour plot generated using data collected by the physical-layer tester of FIG. 6 installed in a system carrying mission-environment data traffic;

FIG. 10 is a high-level schematic diagram of yet another alternative physical-layer tester suitable for use in the test setup of FIG. 1 and that includes a variation on the measurement path circuitry;

FIG. 11 is a high-level schematic diagram of a further alternative physical-layer tester suitable for use in the test setup of FIG. 1 and that includes another variation on the timing path circuitry;

FIG. 12 is an exemplary eye diagram illustrating the operation of physical-layer tester of FIG. 11 when the time-base generator is synchronized to data entering that channel of the physical-layer tester;

FIG. 13 is a high-level schematic diagram of a physical-layer tester suitable for use in the test setup of FIG. 1 and that includes jitter-injection circuitry driving the input port of the serializer;

FIG. 14 is a high-level schematic diagram of one channel of a particular embodiment of the physical-layer tester of FIG. 13 that utilizes unique jitter-injection circuitry that utilizes a digital phase control signal;

FIG. 15 is a high-level schematic diagram of one channel of a physical-layer tester suitable for use in the test setup of FIG. 1 and that includes jitter-injection circuitry downstream of the serializer;

FIG. 16 is a partial high-level schematic diagram/partial isometric view of an exemplary test system that includes the physical-layer tester of FIG. 1 inserted in a high-speed serial link between a mother board and a board under test and in communication with a personal computer; and

FIG. 17 is a partial high-level schematic diagram/partial elevational view of an exemplary test system that includes the physical-layer tester of FIG. 1 inserted in a high-speed serial link between a digital video disk player and a television and in communication with a personal computer.

### DETAILED DESCRIPTION

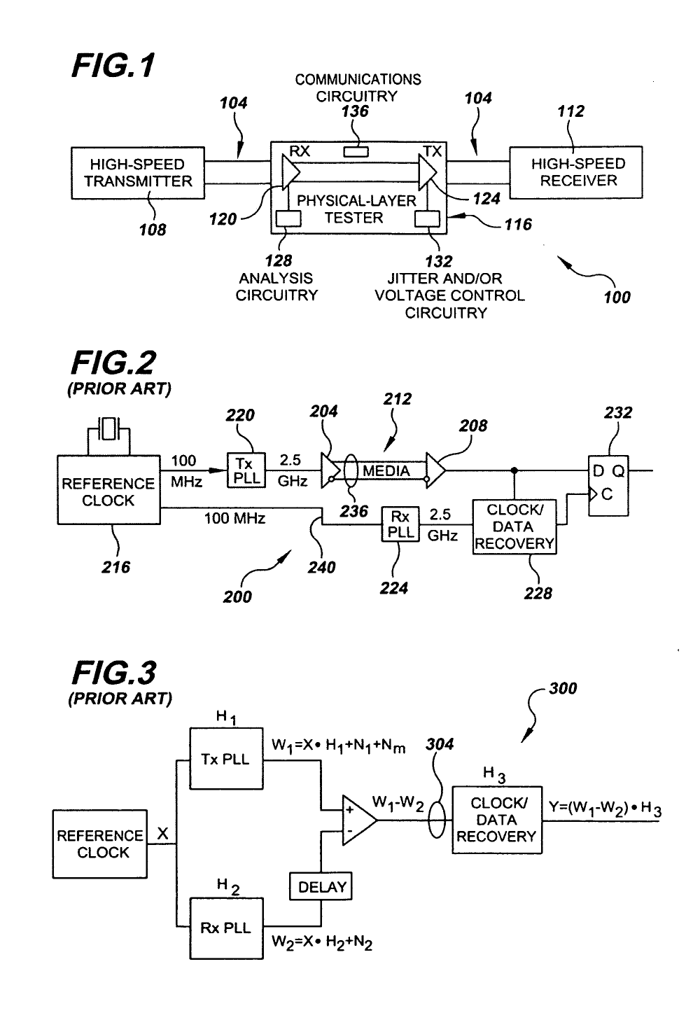

Referring now to the drawings, FIG. 1 illustrates an exemplary test setup 100 of the present invention. In this example, test setup 100 includes a high-speed serial data link 104 connecting a transmitter 108 (which may be part of a transceiver) and a corresponding high-speed receiver 112 (which, too, may be part of a transceiver) that is the intended mission-environment recipient of data transmitted by the transmitter. For the purpose of testing the physical layer of high-speed link 104, test setup 100 also includes a physical-layer tester 116 interposed in the high-speed link between transmitter 108 and receiver 112. As will be described below in detail, a primary purpose of test physical-layer tester 116 is to analyze the physical-layer of high-speed serial interfaces, such as high-speed serial link 104, as they operate within their mission environments.

By “mission environment,” and like terms, it is meant that the components (not shown), for example, motherboard and peripheral card, high-speed storage device and computer, digital media player and video monitor, etc., containing transmitter 108 and receiver 112 and connected by high-speed link 104 are transmitting and receiving, respectively, live, actual data as they would when physical-layer tester 116 is not present in the high-speed link. In other words, the data may be generally characterized as non-deterministic, non-periodic, and non-continuous. As will become apparent from reading the following description, test setup 100 is a low-cost solution to testing the physical layer of high-speed serial link 104. The benefits of this low-cost solution are numerous. For example, physical-layer tests can be performed while the component under test or the system under test is processing mission environment bus traffic. Additionally, all lanes within a bus can be tested simultaneously, and the “analog” signals in the physical layer never have to be routed out through long cables to bench equipment. Quick correlations between protocol failures and physical layer signal integrity can now be made quickly and cost-effectively.

### Physical-Layer Noise and Jitter Budgeting in High-Speed Serial Buses

Before describing details of the exemplary physical-layer tester 116, this section describes the way standards bodies, such as PCI-SIG® (“Peripheral Component Interconnect Special Interest Group” (www.pcisig.com)) define physical-layer parameters such as noise and jitter. In this section, the example of the PCI Express standard is used, although most standards follow the same general principles. They all define the parameters in such a way as to ensure proper operation in a fully assembled serial bus. Other standards include the high-definition multimedia interface (HDMI) standard for high-definition video applications, the 10-gigabit Ethernet attachment unit interface (XAUI) (“X” being “10” in Roman numeral) standard for Ethernet applications, the serial advanced technology attachment (SATA) standard for storage applications, the fully buffered dual in-line memory module (FB-DIMM) standard for memory applications, the high-density multi-chip interconnect (HDMI) standard for multiple-chip integration, the DigRF (“Digital Radio Frequency”) serial standard for base-band and processor interfaces in cell phones, the universal serial bus (USB) standard for interfacing devices, the mobile industry processor interface (MIPI) standard for interfacing mobile devices, and the serial rapid input/output (SRIO) standard for system interconnect applications.

FIG. 2 is a physical-layer diagram of a typical high-speed serial link 200 that is most relevant from a jitter and signal-integrity point of view. Serial link 200 includes a transmit buffer 204 and a receive buffer 208 located across a transmission media 212. On the transmit side, serial link 200 includes a reference clock generator 216 that generates a relatively low-frequency clock signal (here, 100 MHz) and a transmit phase-locked loop (PLL) 220 that multiplies the low-frequency clock signal so as to output a high-frequency carrier signal (here 2.5 GHz). On the receive side, serial link 200 includes a receive PLL 224 that also multiplies the low-frequency clock signal so as to output a high-speed clock signal having a frequency that matches the frequency of the carrier signal. The receive side also includes a clock/data recovery (CDR) circuitry 228 and a sampling flip-flop 232.

As was mentioned above, in a typical application multiple high-speed links are mated to the single clock network and operated simultaneously. The diagram of FIG. 2 suggests the various sources of jitter or noise in a high-speed system and highlights the important observation areas, such as observation point 236, which is a typical location for jitter, noise and bit error rate (BER) testing. For example, jitter from reference clock generator 216 affects both the transmitter and receiver. In the transmitter, the jitter gets filtered by transmit PLL 200, which in turn may add its own jitter/noise. Then, as data is transmitted, transmit buffer 204 and transmission media 212 will both add jitter and noise to the data that is sampled at the receive buffer 208. Transmit buffer 204 may introduce effects such as duty cycle distortion or excessive ringing, while transmission media 212 include effects such as attenuation, signal reflection, skew, and crosstalk. As can be expected, a natural place to observe jitter and waveform shape would be at the output of transmit buffer 204. This can help uncover jitter from transmit PLL 220 and from transmit buffer 204 as well as waveform shape and voltage noise that are impressed on transmission media 212. However, since the verification goal is to verify robust transmission all the way to sampling flip-flop 232 inside the receiver, mathematical models are often required to transform what is measured at this observation point into an estimate of what the sampling flip-flop inside the receiver sees. The first such model attempts to include the effects of the jitter from reference clock generator 216 as seen by the receiver.

Referring still to FIG. 2, CDR circuit 228 in the receiver adds/removes some jitter as follows. First, the jitter from reference clock generator 216 is filtered by receive PLL 224, which may add its own jitter as well. Then, CDR circuit 228 essentially attempts to subtract the jitter in the transmit path (reference clock generator 216+transmit PLL 220+transmit buffer 204+medium 212+receive buffer 208) from the jitter in the reference clock path (reference clock generator 216+delay 240+receive PLL 224) before presenting the data to sampling flip-flop 232. This is done by the combination of receive PLL 224 and the CDR circuit 228. Another model includes the effects of receiver equalization (high-pass filter) (not shown) just before the CDR circuit 228, and yet another model includes the effects of attenuation and crosstalk in transmission media 212. It should be noted that the detailed implementation of various receivers may not be identical to FIG. 2, but the figure is representative of the behavior of most receivers from a jitter and noise point of view.

In view of the above complexity, and because of limitations of conventional measurement systems, the PCI Express standard defines a mathematical model 300 for high-speed serial link 200 of FIG. 2, as illustrated in FIG. 3. As was mentioned, mathematical model 300 is an effort to help engineers translate a measurement at the output of transmit buffer 204 (FIG. 2) (using an oscilloscope, time-interval analyzer, or BER tester (BERT)) or a clock generator into an estimate of what sampling flip-flop 232 sees at the receiver. Mathematical model 300 includes transfer functions for each of the main sources of jitter in a PCI Express link. Details of the mathematical model in this figure are included in the PCI Express jitter specification. Those skilled in the art will readily appreciate that other standards are similar.

### Physical-Layer Measurement Methodology of the Present Invention

As high-speed serial buses become mainstream, test and measurement instruments are starting to incorporate the above-mentioned models as part of their measurement solution. The benefit is that engineers can now spend their time performing the tests and not constructing models such as model 300 in FIG. 3. In contrast, however, in the present disclosure the requirement to model by performing a measurement within a high-speed receiver is eliminated altogether, while taking the effects of transmission media, PLL's buffers, and equalizers all into account directly. This is also done without requiring the stimulus to be deterministic or repetitive.

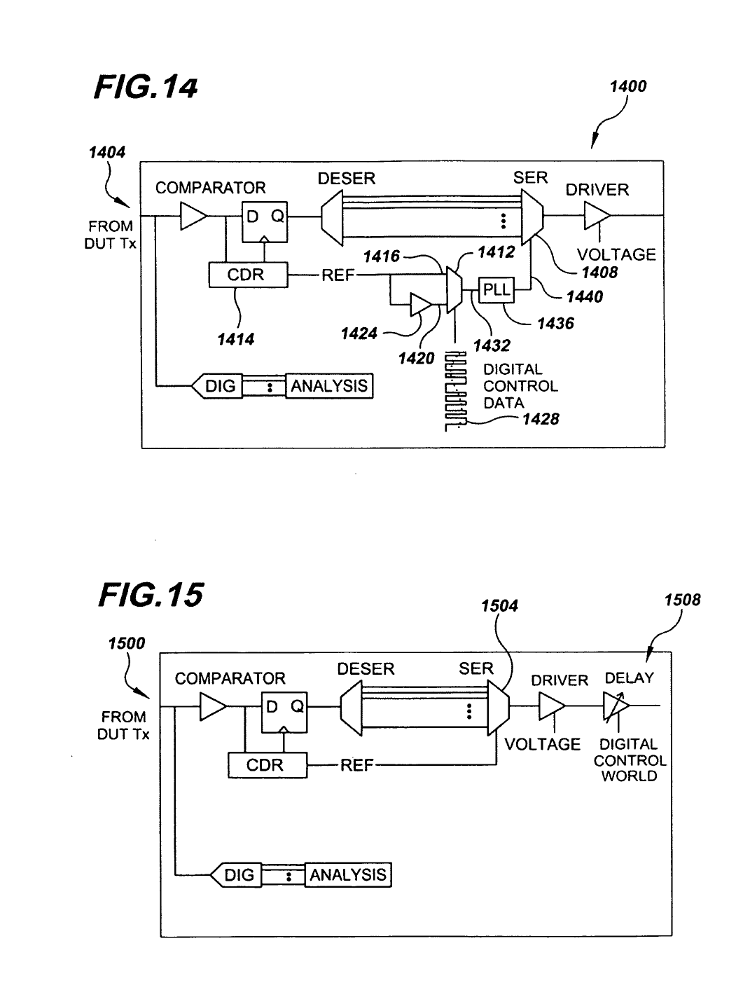

Referring again to FIG. 1, this figure shows test setup 100 of the present invention in which physical-layer tester 116 is placed in the path between mission-environment transmitter 108 and mission-environment receiver 112. Physical-layer tester 116 itself contains a fully functional and compliant receiver 120, as well as a fully functional and compliant transmitter 124. This way, transmitter (under test) 108 is exposed to a real receiver (in this case, receiver 120) at the end of the mission-environment transmission media. Similarly, receiver (under test) 112 is exposed to a real transmitter (in this case, transmitter 124). Physical-layer tester 116 operates inside a real-life link that is carrying arbitrary traffic. So, its main function is to repeat (on its outputs) whatever data it receives on its inputs. Additionally, it may incorporate analysis circuitry 128 to perform physical-layer analysis functions such as jitter and voltage waveform testing (measurement). Additional jitter and/or voltage control circuitry 132 may also be incorporated in tester 116 to insert jitter into receiver under test 112, thus evaluating its jitter tolerance. This operation is described well in U.S. patent application Ser. No. 11/553,035, filed Oct. 26, 2006, and titled “High-Speed Transceiver Tester Incorporating Jitter Injection” (“the '035 application”) which is incorporated herein by reference for all of its teachings regarding jitter injection and jitter testing. In addition, other circuitry may include communications circuitry 136 for communicating with an external device, such as a general purpose computer (see FIGS. 13 and 14) that allows a user to interface with the physical-layer tester and run an associated software graphical user interface (GUI).

Referring back to FIG. 3 that illustrates mathematical model 300 of the PCI Express standard, this figure also shows the location of an observation point 304 for the systems and methods of the present disclosure. As described below in detail, systems of the present disclosure incorporate a fully functional high-speed serial receiver, and they place the observation point for jitter measurement right inside the receiver. As such, a measurement, such as an eye diagram, performed by these systems includes all the jitter effects described in the previous section (reference clock+transmit PLL+transmit buffer+medium+receive buffer+receive PLL). This represents the most relevant jitter measurement on multiple active lanes in the industry, and it enables engineers to evaluate the BER performance of the whole serial link (combination of transmitter and receiver) with real-life traffic. An eye opening measured by a system of the present disclosure represents a direct evaluation of the amount of margin in the sampling instance of the receiving flip-flop. No modeling effort is required. The same can be said for any BER measurement performed. With systems of the present disclosure, BER values can be correlated with higher-level system metrics such as protocol failures or re-transmits.

### Exemplary Embodiments of a Physical-Layer Tester

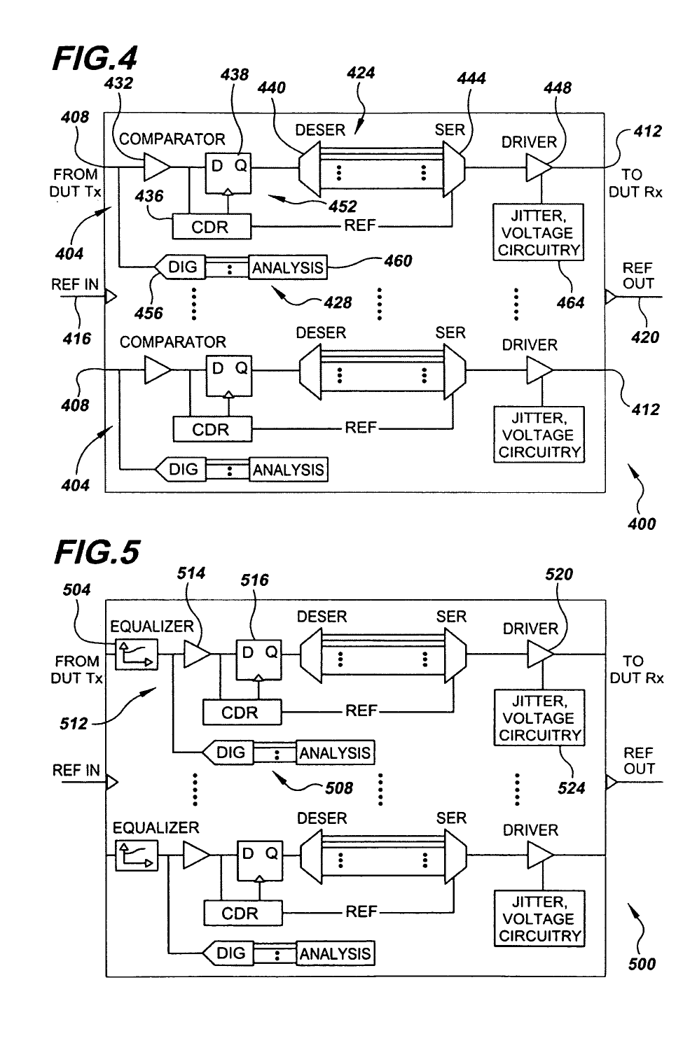

FIG. 4 illustrates a physical-layer tester 400 that may be used as physical-layer tester 116 in test setup 100 of FIG. 1. In this example, physical-layer tester 400 is a multi-channel tester having a number of channel circuits 404 that will typically be equal to the number of individual serial links, for example, of a multi-channel bus, being tested. That said, the number of channel circuits 404 may be different in the case of, for example, an embodiment that can test serial link buses of differing number of channels, in which case during tests of buses having fewer channels certain ones of the channel circuits of physical-layer tester 400 are not used. Typically, though not necessarily, each channel circuit 404 is identical to each other channel circuit within physical-layer tester 400. Consequently, for convenience the various elements of only one channel circuit 404 are labeled and described. The unlabeled elements of the other channel circuits shall be assumed to be the same as the corresponding elements of the labeled circuit channel 404.

Physical-layer tester 400 includes a data input 408 and a data output 412 for each channel circuit 404. As those skilled in the art will readily appreciate, each input 408 and output 412 may be part of a suitable respective input or output connector, such as a 36-pin, 64-pin, 98-pin connector, or 164-pin connector, depending on the number of channels being tested. Physical-layer tester 400 may also include a reference clock input 416 and a reference clock output 420 for, respectively, receiving a reference clock signal and passing the reference clock signal out of the tester. Reference clock input and output 416, 420 may also be part of the connectors mentioned above. During testing, some or all of data inputs 408 and reference clock input 416 are electrically connected to a transmitter under test (not shown), and some or all of data outputs 412 and reference clock output 420 is electrically connected to a receiver under test (not shown).

Each circuit channel 404 may include two paths for the high-speed serial data coming into physical-layer tester 400. The first path is a functional data path 424 that passes data from the transmitter under test (i.e., mission-environment transmitter) through physical-layer tester 400 to the receiver under test (i.e., mission-environment receiver). The second path is a measurement path 428 that may be configured to analyze various analog parameters of the input signal, for example, its eye opening and jitter. Data path 424 may include a comparator 432 and/or equalization network (see FIG. 5) followed by CDR circuit 436 that includes a sampler (here, a flip-flop 438), which is followed by deserialization (de-mux) circuitry 440. The data deserialized by de-mux circuitry 440 is routed to respective data output 412 through a serializer (mux) 444 and a voltage driver 448. In this example, serializer 444 is synchronized to receiver circuitry 452 so that no packets are lost in this transmission process. The need to de-serialize the data and then serialize it is driven by one of the digitizer embodiments below. In general, this step of de-serializing and then serializing can be skipped, or it may not be needed if the digitizer embodiment allows it.

In this embodiment, before arriving at comparator 432, the input signal is routed to measurement path 428 that includes a digitizer 456 for digitizing the input high-speed serial data signal and an analyzer 460 for analyzing parameters of the input signal, such as eye opening and jitter as mentioned above. The routing needs to happen with minimal perturbation to the input signal parameters. That is, the distance between measurement path 428 and data path 424 needs to be minimal and the capacitive and inductive loading needs to be minimized. In an integrated environment, this routing is preferred to occur after the termination network of the transmission line. Strictly speaking, measurement path 428 may be considered to extend all the way to voltage driver 448 (transmitter). That is, additional measurement-related circuitry 464 may be provided to voltage driver 448 to enable jitter injection or voltage sweeping. The '035 application, which discloses a high-speed transceiver tester incorporating jitter injection wherein jitter injection is performed on an active high-speed transmitter without requiring any modifications to the main elements in the transmitter, described this in detail. The '035 application is incorporated herein by reference for its teachings of jitter injection in this manner. Particular examples of jitter-injection schemes are described in more detail below in connection with FIGS. 13-15.

An advantage of physical-layer tester 400 is that it provides a sense for the signal shape and jitter right at the input of a real-life receiver, i.e., receiver circuitry 452 aboard the tester. It is equivalent to placing an oscilloscope probe right at the input pads of a device while it is operating. For very high frequency applications (e.g. 5 Gbps and beyond), the signal at this location is barely visible, and additional digital equalization circuitry inside the receiver of a physical-layer tester of the present disclosure is required to amplify it and condition it. Being able to observe the signal shape after the equalization circuitry is desirable. For such situations, the configuration of physical-layer tester 500 of FIG. 5 may be used, for example, as physical-layer tester 116 of FIG. 1. The configuration of physical-layer tester 500 is applicable primarily for linear equalizers, such as linear equalizer 504. As can be seen, a difference between physical-layer testers 400, 500 of FIGS. 4 and 5, respectively, is that in physical-layer tester 500 of FIG. 5 the measurement path 508 is inserted in the receiver circuitry 512 after input equalizer 504 (and before the comparator 514), thus enabling the measurement of the high-speed signal after it has been amplified by the equalizer. Again, the motivation here is to observe exactly what the sampler (flip-flop 516 in FIG. 5) sees and whether there is enough margin in its sampling window. As in physical-layer tester 400 of FIG. 4, the transmitter 520 of physical-layer tester 500 in FIG. 5 may rely on subject matter of the '035 application so as to contain both jitter insertion and voltage swing control circuitry 524.

### Digitizer Embodiments

As can be seen from the above description, receiver circuitry 452, 512 (FIGS. 4 and 5, respectively) of physical-layer testers 400, 500, respectively, is more complicated than the transmitter circuitry, as it includes a means for digitizing the analog shape of the incoming signals. This section describes different methods for implementing the digitization process.

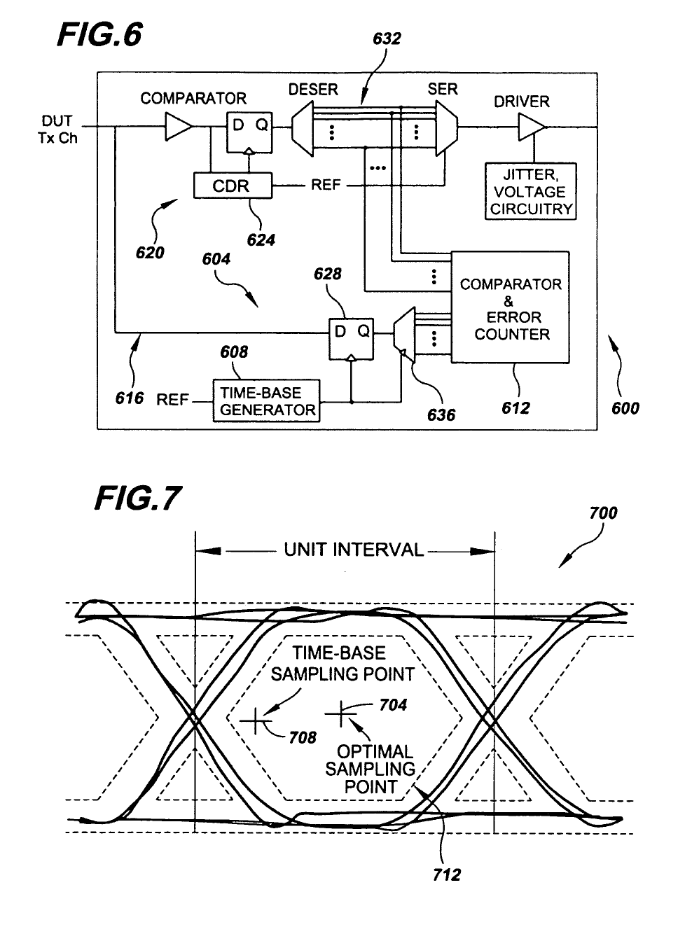

FIG. 6 shows a physical-layer tester 600 that includes exemplary digitizer circuitry 604. It is noted that only one channel is shown for convenience. As with physical-layer testers 400, 500 of FIGS. 4 and 5, respectively, physical-layer tester 600 of FIG. 6 may, however, include as many channels as desired. Physical-layer tester 600 may be used for physical-layer tester 116 of FIG. 1 to test the serial bus interface between mission-mode transmitter 108 and mission-mode receiver 112. Digitizer circuitry 604 includes a time-base generator 608 coupled with pattern-comparison-and-error-counting-analyzer (logic) 612 to implement a highly versatile jitter-and-eye-opening measurement solution. Time-base generator 608 may be made in accordance with U.S. patent application Ser. No. 11/776,825, filed on Jul. 12, 2007, and titled “Signal Integrity Measurement System and Method Using a Predominantly Digital Time-Based Generator” (“the '825 application”), which is incorporated herein by reference for all its teachings relating to time-base generators. The first remark to be made about the measurement path 616 in physical-layer tester 600 is that it almost consists of second mission-environment receiver. It is said “almost” because generally the only difference between measurement path 616 and the data path 620 is that the CDR circuit 624 is replaced by time-base generator 608. The combination of time-base generator 608 and the sampler 628 (a flip-flop is shown, but it could be any suitable sampler, such as a comparator) is described in detail in the '825 application.

Time-base generator 608 essentially consists of a modified CDR circuit that allows for placing the sampling instance of sampler 628 anywhere in time (with respect to a reference clock signal (labeled “Ref.” in FIG. 6)). This reference signal “Ref” can literally be the input clock of tester 600 (the input clock is not shown in FIG. 6, but which may be similar to input clock 416 of tester 400 in FIG. 4) or it could be the output clock of CDR circuit 624. When coupled with analysis logic 612, time-base generator 608 and sampler 628 constitute a high-bandwidth sub-sampling digitizer. They also constitute a versatile BERT with sub-pico-second delay-line resolution. To perform eye-margining tests such as a BER contour plot, the pattern comparator and error counter analysis logic 612 may receive a “reference” pattern from the parallel portion 632 of data path 620. The reader is reminded that data path 620 has an active CDR circuit 624, so it samples the incoming data optimally. Time-base generator 608 margins the same data signal in voltage and time (i.e. samples it at different voltages and time locations). Discrepancies between the data path packets and the measurement path packets are analyzed in order to extrapolate timing parameters.

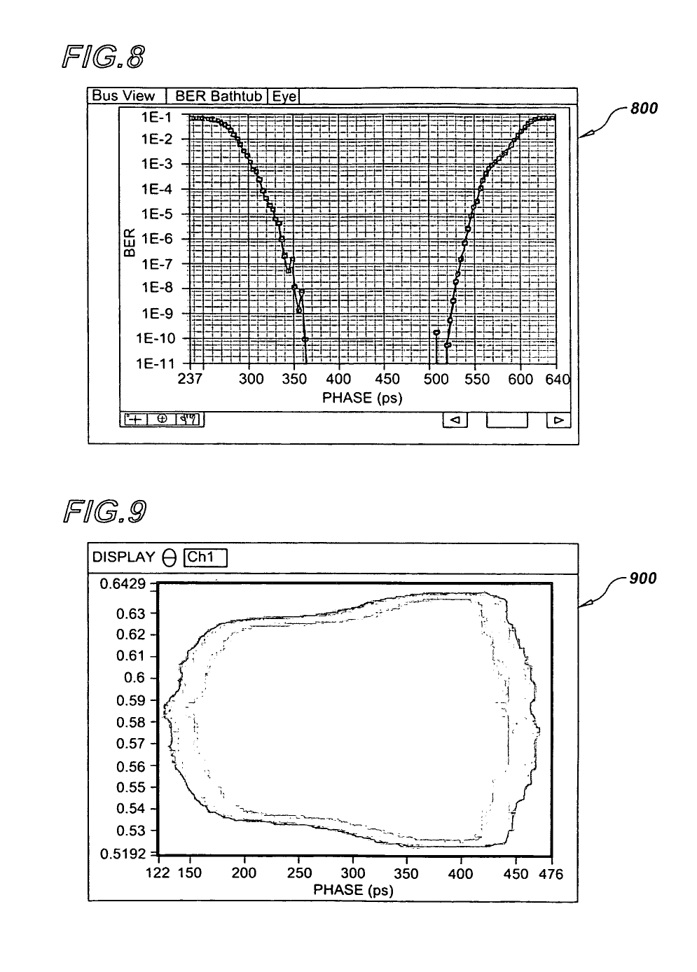

Referring now to FIGS. 7-9, and also to FIG. 6, FIG. 7 shows a sample eye diagram 700 that illustrates exemplary sampling instants 704, 708 relative to the high-speed serial data signal being intercepted by physical-layer tester 600. By comparing received data at optimal sampling instant 704 to measured data at measurement-path sampling instant 708, phenomena such as jitter and eye shape can be extracted. The configuration of physical-layer tester 600, particularly time-base generator 608, allows the tester to sample the incoming signal anywhere in the eye 712. FIG. 8 shows an exemplary plot 800 of a BER bathtub curve constructed using physical-layer tester 600 of FIG. 6 inserted in a live PCI-Express application (not shown). Similarly, FIG. 9 shows a BER contour plot 900 (also known as eye diagram) of data collected by physical-layer tester 600 of FIG. 6 for a system (not shown) carrying live traffic. Lighter shades in plot 900 correspond to highly likely waveform transitions, whereas darker shades correspond to low probabilities of waveform transitions.

One way plot 800 in FIG. 8 is obtained is as follows. First, time-base generator 608 is programmed to place sampling instant 708 at a much earlier time than optimal sampling instant 704. Then, error logic 612 compares reference data from data path 620 to received data from measurement path 616 with this time-base setting. Error counts are taken and recorded in memory by error logic 612 or transmitted through a communications interface (not shown) to, for example, a personal computer. Subsequently, time-base generator 608 is programmed to shift sampling instant 708 to a slightly later point. Eventually, the whole horizontal axis is covered and comparisons between reference data and measurement path data are made. Other embodiments of this digitization process can be understood from the '825 application.

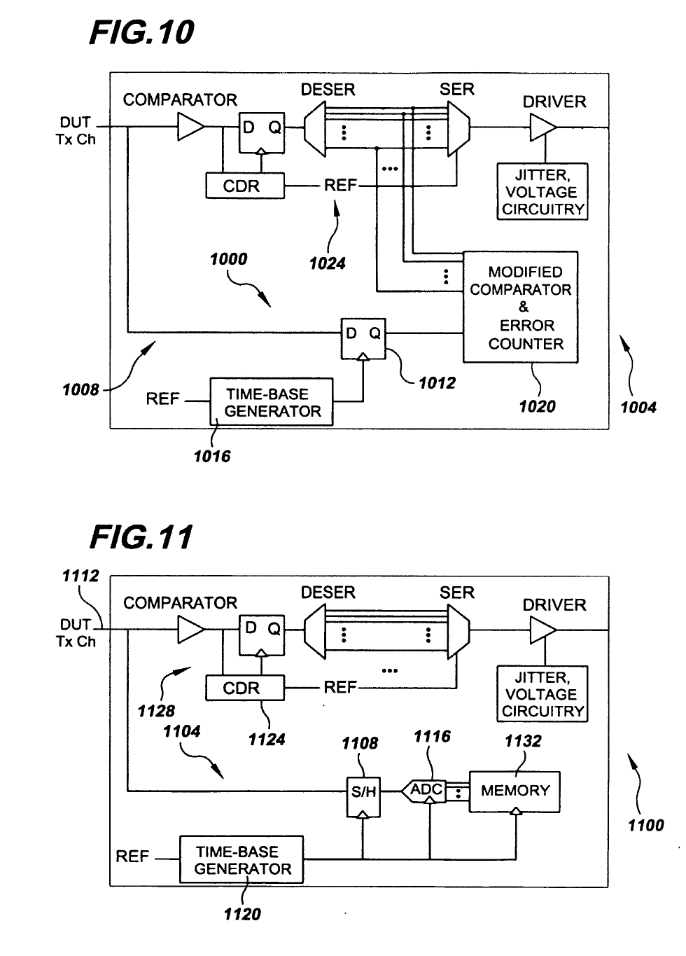

With reference now to FIG. 10, and also to FIG. 6 for the sake of comparison, FIG. 10 illustrates a second embodiment 1000 of a digitizer in the context of another physical-layer tester 1004 made in accordance with the present invention. In physical-layer tester 1004, the complexity of measurement path 1008 is reduced, though at the potential expense of test time. Specifically, instead of constructing complex receiver circuitry like the de-mux 636 of FIG. 6, the measurement signal is sub-sampled via sampler 1012 and time-base generator 1016 at a rate that is manageable for the comparator and error counter analyzer logic 1020. For example, if the data path 1024 has a ×16 deserialization factor (i.e., it slows down the incoming signal frequency by a factor of 16), the sampler 1012 (e.g., flip-flop or comparator) in measurement path 1008 can be clocked by time-base generator 1016 at this slow frequency. If the reference signal Ref provided to time-base generator 1016 is too fast, the latter can implement a frequency divider (not shown) to match the desired sampling rate. At this sampling rate, measurement path 1008 does not sample every single transition in the incoming data stream; rather, it samples every 16th transition. Since a purpose of the physical-layer measurement is to obtain a statistical view of the performance of the serial link, missing transitions is typically not a significant limitation (same as oscilloscopes). Performing this sub-sampled digitization process over longer intervals is generally equivalent to analyzing every single transition. Bathtub curve plots and eye contour plots similar to bathtub curve plot 800 and BER contour plot 900 shown in FIGS. 8 and 9, respectively, may be similarly obtained by comparator and error counter analyzer logic 1020. It is noted that in this example pattern comparator and error counter logic 1020 is modified in such a way that allows it to skip transitions (every 16th transition in the example used here). Those skilled in the art will readily understand how to modify comparator and error counter analyzer logic 1020 in this manner.

Referring still to FIGS. 6 and 10, the clocking schemes in physical-layer testers 600, 1004 are now described. It was mentioned above that one of the benefits of a system/method of the present disclosure is that it can account for all PLLs in a high-speed serial path. Here, we indicate how this is achieved. In FIGS. 6 and 10 we see that each of the corresponding time-base generator 608, 1016 is driven by the same reference clock signal Ref as the circuitry along the respective data path 620, 1024. Depending on the bus architecture and implementation specifics of the respective physical-layer testers 600, 1004, the manipulations of reference clock signal Ref in the corresponding measurement path 616, 1008 can be made equivalent to the manipulations the reference clock signal is subjected to in respective data path 620, 1024.

For example, as seen in FIG. 2, in the PCI Express standard the reference clock goes through receive PLL 224. In a physical-layer tester of the present disclosure utilizing the technology in the '825 application incorporated by reference above, the reference clock goes through a second PLL (not shown) inside the time-base generator, and this second PLL has the same loop parameters as the PLL in the data path. Conversely, for applications with no reference clock, the recovered clock from the CDR in the data path can be used to drive the clock in the time-base generator, substantially synchronizing the measurement path to the data path. This synchronization is important for situations in which spread-spectrum clocking is deployed. In such a situation, the transmitted serial data is slowly modulated in frequency and any receiver coupled to this data is expected to constantly track this frequency modulation. In order to measure such a signal, the test instrument needs to mimic this tracking capability. Using the recovered clock from the actual receiver's CDR to drive the time-base generator achieves this goal without requiring mathematical models.

FIG. 11 illustrates a physical-layer tester 1100 made in accordance with concepts of the present invention in which the measurement path 1104 includes a sample-and-hold (S/H) circuit 1108 that samples the high-speed signal on input line 1112 coming from a transmitter under test, a.k.a., mission-environment transmitter (denoted in FIG. 11 as “DUT Tx Ch” for “device-under-test transmitter channel”). S/H circuit 1108 is then followed by a low-frequency and/or low-complexity analog-to-digital converter 1116. As those skilled in the art will appreciate, to keep implementation area low, a simple successive-approximation converter can be used for converter 1116. Alternatively, the digitizer concepts in U.S. Pat. No. 6,931,579 to Roberts et al., which is incorporated by reference herein for its digitizer teachings, can be used. The advantage of physical-layer tester 1100 is that, again, it does not require repetitive or deterministic data. It does, however, require synchronization to the incoming high-speed data. This synchronization is again achieved using a time-base generator 1120 that is deployed according to the system architecture. That is, if the architecture relies on a reference clock, time-base generator 1120 is driven by this clock. However, if the architecture relies on an embedded clock, the time-base generator relies on the recovered clock from the CDR circuitry 1124 in the data path 1128. Output from analog-to-digital converter 1116 may be stored in a capture memory 1132 for use in analyzing one or more parameters of the input high-speed serial data signal under consideration, for example, by circuitry (not shown) aboard physical-layer tester 1100 and/or an external device (not shown), such as a personal computer.

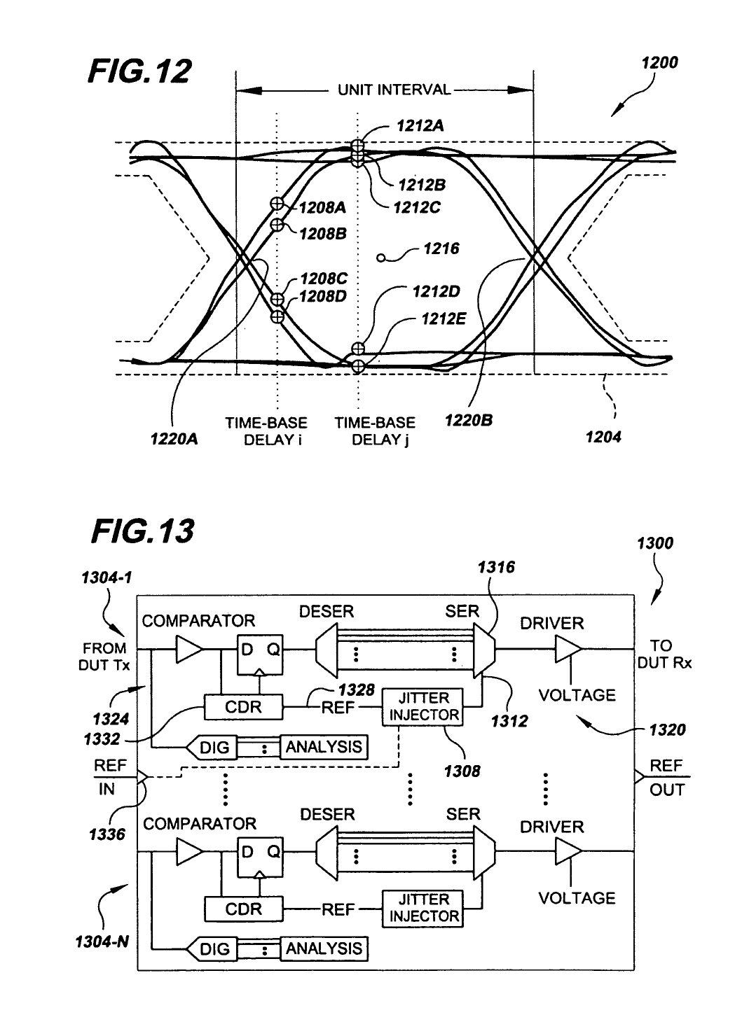

Referring to FIG. 12, which shows an exemplary eye diagram 1200, and also to FIG. 11, for each point along a horizontal axis 1204 of the eye diagram, a voltage in the incoming serial data stream is sampled and digitized several times, as indicated at the multiple sampling points 1208A-D, 1212A-E at differing time base delays “i” and “j”. In this example, time-base generator 1120 is synchronized to the incoming high-speed serial data signal, so multiple transitions can be overlaid on top of one another as shown. Depending on the delay set by time-base generator 1120, S/H circuit 1108 will sample various voltage levels. At delay “j,” it will either sample low voltages or high voltages. That is, for locations close to the center of the eye 1216, the sampled voltages are either going to be predominantly high or predominantly low. For locations close to the transition edges 1220A-B of eye 1216, the sampled voltages are going to vary depending on jitter, rise-time, and fall-time. Like physical-layer tester 1004 of FIG. 10, physical-layer tester 1100 of FIG. 11 is sub-sampling in nature. Also, it is noted that a limitation of physical-layer tester 1100 is that a sample-and-hold circuit 1108 must be relatively fast. However, converter 1116 at the output of S/H circuit 1108 does not have to be fast, but it cannot be too slow in order to mitigate droop effects in the S/H process. As was mentioned above, a successive approximation analog-to-digital converter or a small pipelined analog-to-digital converter can be deployed as converter 1116. In this example, the output of converter 1116 is stored in digitized-waveform memory 1132. Overlaying many digitization passes over each other in software or hardware results in an eye diagram representation like eye diagram 700 of FIG. 7.

### Jitter Injection/Driver Circuitry Embodiments

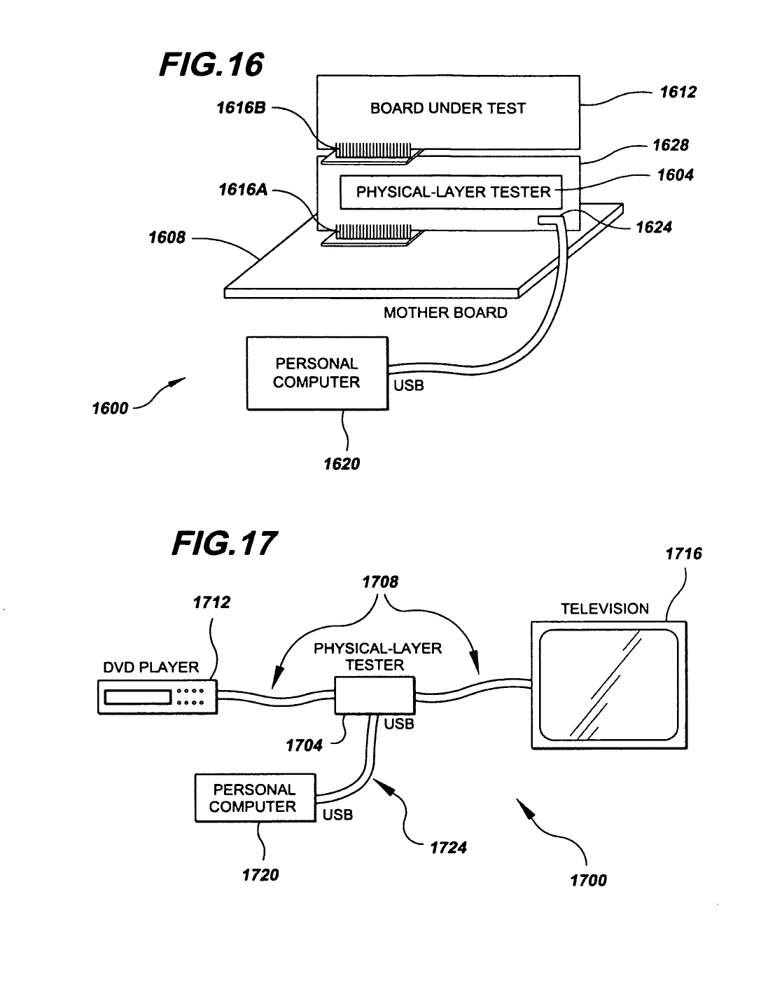

As discussed above, the driver in a physical-layer tester made in accordance with concepts of the present invention is intended to stress the mission-environment receiver (illustrated as receiver 112 in FIG. 1, and in the context of the examples of FIGS. 16 and 17 the mission-environment receiver could be either board under test 1612 or mother board 1608 (FIG. 16) or either television 1716 or DVD player 1712 (FIG. 17), depending on the data direction being tested). It is thus required to impress controlled amounts of jitter (timing perturbation) on the output of the physical-layer tester as the driver repeats the data received from mission-environment transmitter (illustrated as transmitter 108 in FIG. 1, and in the context of the examples of FIGS. 16 and 17 the mission-environment receiver could be either mother board 1608 or board under test 1612 (FIG. 16) or either DVD player 1712 or television 1716 (FIG. 17), depending on the data direction being tested). FIGS. 13-15 illustrate several examples of how a physical-layer tester made in accordance with the present invention can be provided with driver circuitry capable of intentionally stressing the mission-environment receiver as desired for a particular mission-mode test.

Referring first to FIG. 13, this figure illustrates a physical-layer tester 1300 that can be used in test setup 100 of FIG. 1, if desired. Physical-layer tester 1300 is presented to illustrate one scheme for implementing jitter-injection circuitry for stress-testing a mission-environment receiver, such as receiver 112 of FIG. 1. Like other physical-layer testers disclosed herein, physical-layer tester 1300 is a multi-channel tester having a plurality of identical channels 1304-1 to 1304-N in a number suitable for the mission-environment device(s) (not shown) that the tester is designed to test. For convenience, only channel 1304-1 is described, as the remaining channels are virtually identical to this channel. As seen, channel 1304-1 includes a jitter injector 1308 that drives the input port 1312 of serializer 1316 so as to controllably introduce jitter into the serialized output of the serializer that is subsequently provided to the mission-environment receiver (not shown). Jitter injector 1308 may comprise any suitable circuitry for driving serializer 1316 in a manner that causes jitter on the output signal of the serializer. Those skilled in the art will readily appreciate that although the components of physical-layer tester 1300 other than jitter injector 1308 are shown as being the same as the like components of physical-layer tester 400 of FIG. 4, alternative embodiments of physical-layer testers incorporating jitter injectors similar to jitter injector 1308 may have other components similar to other physical-layer testers disclosed herein, such as physical-layer testers 500, 600, 1004, 1100 of, respectively, FIGS. 5, 6, 10 and 11.

The transmitter 1320 of physical-layer tester 1300 needs to be synchronized to the receiver 1324 so that no data bits are lost. This can be achieved by clocking jitter injector 1308 using either the recovered clock output 1328 of CDR circuit 1332 or the main reference clock input 1336 that is supplied by the mission-environment transmitter (not shown, but see transmitter 108 of FIG. 1). Whichever of these clocks is routed to the jitter injector 1308 is the one that is manipulated by the jitter injector to drive serializer 1316. Benefits of this configuration are that the serializer/driver circuit is not modified in physical-layer tester 1300 and the data is not lost.

One particular example 1400 of jitter injector 1308 is shown in FIG. 14 in the context of a single physical-layer tester channel 1404. In this example, jitter injector 1400 and its interaction with serializer 1408 are executed in accordance with the teachings of the '035 application mentioned and incorporated herein by reference above. Briefly, jitter injector 1400 includes a multiplexer 1412 having the clock reference signal Ref recovered by CDR 1414 circuitry as one of its selectable inputs 1416 and a delayed version of this clock reference signal Ref as the other of its selectable inputs 1420. As is described in detail, the delayed version of clock reference signal Ref is created using a coarse delay element 1424. Multiplexer 1412 continually selects between the two selectable inputs 1416, 1420 as a function of a digital control data signal 1428 (a.k.a. a “phase-selecting signal”) so as to create a rapidly varying phase-modulated output signal 1432 that is provided to a phase filter, here PLL 1436. As described in the '035 application, digital control data signal 1428 may be the output of a sigma-delta modulator (not shown), which may be simulated, for example, using a circular memory. The phase filter receives and filters from phase-modulated output signal 1432 high-frequency components so as to generate a filtered output signal 1440 that controls serializer 1408 in a manner that controllably introduces jitter into the data as it is serialized by the serializer. Further details and alternative embodiments of jitter injectors similar to jitter injector 1408 are described in the '035 application. It is noted that aspects of physical-layer tester channel 1404 are shown as being identical to channel 1304-1 of FIG. 13 for convenience and that, like channel 1304-1, these aspects of physical-layer tester channel 1404 may differ in the manner described above relative to physical-layer tester 1300.

FIG. 15 illustrates an alternative physical-layer tester channel 1500 in which jitter is injected into the mission-mode data stream downstream of the serializer 1504 by a jitter injector 1508. By virtue of its location, jitter injector 1508 can be implemented with conventional jitter injection circuitry, such as delay line circuitry. Other jitter injection mechanisms such as the mechanisms disclosed in U.S. Pat. No. 7,315,574 can also be deployed in jitter injector 1508. U.S. Pat. No. 7,315,574 is incorporated by reference herein for its teachings on jitter injection. Those skilled in the art will understand ways in which jitter injector 1508 can be implemented such that further discussion on this point is not necessary. As with physical-layer tester channel 1404 of FIG. 14, it is noted that aspects of physical-layer tester channel 1500 of FIG. 15 other than the jitter injection scheme are shown as being identical to channel 1304-1 of FIG. 13 for convenience and that, like channel 1304-1, these aspects of physical-layer tester channel 1500 may differ in the manner described above relative to physical-layer tester 1300.

### Communications and Exemplary Applications

FIGS. 16 and 17 illustrate two of many applications for test setup 100 of FIG. 1. FIG. 16 shows a testing system 1600 configured in accordance with concepts of the present invention. In this example, a physical-layer tester 1604, which may be, for example, any one of physical-layer testers 400, 500, 600, 1004, 1100, 1300, is inserted into the high-speed serial link present between a motherboard 1608 and a board under test 1612. As those skilled in the art will readily appreciate, motherboard 1608 may be the motherboard of any suitable device, such as a general purpose computer (e.g., personal computer), gaming device, a lap-top computer, an embedded computer system, and a server, among many others. Correspondingly, board under test 1612 may be any suitable “card” or peripheral board compatible with motherboard 1608. Examples of board under test 1612 include sound cards, graphics accelerators, Ethernet cards, disk drive controllers, and video tuners, among many others.

In this example, the high-speed serial link is a PCI Express link, which is represented by mating connectors 1616A-B on motherboard 1608 and board under test 1612, but is actually embodied, as those skilled in the art will readily understand, in the circuitry and software of the motherboard and board under test. Also in this example, the physical-layer measurements are performed using physical-layer tester 1604 in conjunction with a personal computer (PC) 1620. Although a PC is shown, those skilled in the art will readily appreciate that other devices may be used for interfacing with physical-layer tester 1604, such as handheld devices and dumb terminals, among many others. Generally, the type of user interface hardware required will depend on how much computing power and how much of the user interface is built into physical-layer tester 1604. On balance, though, it is presently envisioned, though not required, that at least the majority of the user interface for physical-layer tester 1604 reside on a general purpose computer. Computer 1620 is in communication with physical-layer tester 1604 using a suitable communication link 1624, such as the universal serial bus (USB) link shown.

In some examples, this communications link 1616 comprises a JTAG (Joint Test Action Group, or IEEE Standard 1149.1) port to on-board memory (not shown) that holds the digitized data from the measurement path. Communications link 1616 is also coupled to a control state machine (not shown) that commands the time-base generator, the jitter injection control block, and the voltage control block of each channel of physical-layer tester 1604. Commands to start an acquisition or to control the amount of injected jitter are transmitted from PC 1620 (in a GUI) to physical-layer tester 1604 through this communications link 1616. A typical and preferred way to implement this communications connection is through USB, although any bus connection scheme can be used.

As can be seen in FIG. 16, physical-layer tester 1604 resides on a board 1628 that has the PCI-Express form-factor and is functionally connected between motherboard 1608 and board under test 1612. This way, motherboard 1608 “thinks” it's communicating with board under test 1612, and the board under test “thinks” it's communicating with the motherboard. Physical-layer tester 1604 passes actual mission-environment data traffic back and forth between motherboard 1608 and board under test 1612 transparently via its data paths on it various channels as described above, while at the same time measurements of this traffic are being taken on the measurement paths of its various channels in any one or more of the manners described above.

FIG. 17 shows a testing system 1700 that includes a physical-layer tester 1704 operatively inserted into a high-speed serial link 1708 between a digital media player, such as a digital video disk (DVD) player 1712 and a video display/projector, for example television 1716, as is common today in many home entertainment systems. Like physical-layer tester 1604 of FIG. 16, physical-layer tester 1704 of FIG. 17 may be, for example, any one of physical-layer testers 400, 500, 600, 1004, 1100, and may be interfaced with a user-interface device, such as personal computer 1720, using any suitable communications scheme, such as USB link 1724 shown. When testing is not being conducted, physical-layer tester 1704 will typically not be present, and DVD player 1712 will be directly connected to television 1716.

During testing, physical-layer tester 1704 may gather and/or analyze (test), with and/or without the aid of personal computer 1720, the performance of high-speed serial link 1708 in any one or more of the manners described above. As mentioned before, an important benefit of testing system 1700 is that this testing can be performed while DVD player 1712 is streaming actual video and sound data to television 1716, with physical-layer tester 1704 passing the data through itself on one or more data paths (not shown) while also collecting and/or analyzing the data via one or more corresponding respective measurement paths. While two exemplary applications of test setup 100 of FIG. 1 have been illustrated in FIGS. 16 and 17, those of ordinary skill in the art will understand how to implement the present invention for a wide variety of mission-environment testing applications without undue experimentation using the present disclosure as a guide.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for testing a high-speed serial link, comprising:
a physical-layer tester configured to be inserted into a high-speed serial link between a mission-environment transmitter and a mission-environment receiver, said physical-layer tester comprising:
a tester receiver for receiving high-speed serial data from the mission-environment transmitter;
a tester transmitter for transmitting the high-speed serial data to the mission-environment receiver;
a data path extending between said tester receiver and said tester transmitter so as to carry the high-speed serial data from said tester receiver to said tester transmitter without loss; and
a measurement path in communication with said tester receiver for receiving the high-speed serial data, said measurement path including measurement circuitry for measuring characteristics of the high-speed serial data.

2. A system according to claim 1, wherein said tester transmitter includes jitter and voltage control circuitry for stress testing the mission-environment receiver.

3. A system according to claim 1, wherein said mission-environment transmitter and mission-environment receiver are transferring data that is non-deterministic, non-periodic, and non-continuous.

4. A system according to claim 1 wherein said mission-environment transmitter and mission-environment receiver are transferring data that is deterministic and periodic and continuous.

5. A system according to claim 1, wherein said data path includes a deserializer and a corresponding serializer functionally connected to said deserializer downstream of said deserializer.

6. A system according to claim 5, wherein said tester receiver includes clock-and-data-recovery circuitry functionally connected upstream of said deserializer, and said serializer is clocked by an output of said clock-and-data-recovery circuitry.

7. A system according to claim 1, wherein the high-speed serial data is carried by a signal and said tester receiver includes an equalizer for amplifying and conditioning the signal.

8. A system according to claim 1, wherein the high-speed serial data is carried by a signal and said measurement circuitry includes a digitizer for digitizing said signal into a digitized signal.

9. A system according to claim 8, wherein said digitizer includes a time-base generator and a sampler clocked by said time-base generator.

10. A system according to claim 8, wherein said digitizer comprises a flip-flop.

11. A system according to claim 8, wherein said digitizer comprises sample-and-hold circuitry.

12. A system according to claim 11, wherein said measurement path includes an analog-to-digital converter located downstream of said digitizer.

13. A system according to claim 8, wherein said measurement circuitry includes signal-analysis circuitry for analyzing said digitized signal and producing analysis data.

14. A system according to claim 13, wherein said signal-analysis circuitry comprises a digital comparator and error counter circuitry.

15. A system according to claim 13, wherein said measurement circuitry includes a data capture memory for storing the analysis data.

16. A system according to claim 15, further comprising communication circuitry for communicating the analysis data to a device external to said physical-layer tester.

17. A system according to claim 13, wherein said measurement circuitry further includes a first deserializer electrically connected between said digitizer and said signal-analysis circuitry.

18. A system according to claim 17, wherein said first deserializer deserializes the high-speed serial signal onto a plurality of parallel data lines, and said signal-analysis circuitry is in communication with ones of said plurality of parallel data lines.

19. A system according to claim 17, wherein said signal analysis circuitry includes a comparator and said physical-layer tester further comprises a second deserializer electrically connected between said comparator and a point upstream of said digitizer, said comparator configured to compare signals output from said first deserializer to signals output from said second deserializer.

20. A system according to claim 19, wherein said comparator comprises a programmable threshold comparator.

21. A system according to claim 20, wherein said programmable threshold comparator comprises a digitally controlled programmable threshold comparator.

22. A system according to claim 1, wherein said physical-layer tester further comprises a reference clock input for receiving an external reference clock signal, portions of each of said data path and said measurement path being clocked by said external reference clock signal.

23. A system according to claim 1, wherein said tester receiver includes clock-and-data-recovery circuitry and said measurement circuitry includes a time-base generator clocked by said clock-and-data-recovery circuitry.

24. A system according to claim 1, wherein said physical-layer tester receives an external reference clock during testing and said measurement circuitry includes a time-base generator clocked by the external reference clock during testing.

25. A system according to claim 1, wherein the high-speed serial data is output by said physical-layer tester as an output data signal during testing and said physical-layer tester includes a jitter injector that injects jitter into the output data for stress-testing the mission-environment receiver.

26. A system according to claim 25, wherein said data path includes a serializer and said jitter injector is located downstream of said deserializer.

27. A system according to claim 25, wherein said data path includes a serializer having a select port, said jitter injector configured to drive said select port.

28. A system according to claim 27, wherein said jitter injector rapidly selects between a reference clock signal and a delayed version of the reference clock signal so as to create a phase-modulated signal.

29. A system according to claim 28, wherein said jitter injector comprises a phase filter for filtering the phase-modulated signal prior to driving said select port of said serializer.

30. A system according to claim 1, wherein the high-speed serial data is carried by a data signal and said data path receives the data signal, said measurement circuitry electrically configured to measure the data signal that is also received by said data path.

31. A method of testing a high-speed serial link between a mission-environment transmitter and a mission-environment receiver, comprising:
receiving high-speed serial data signal from a mission-environment transmitter;
transmitting the received high-speed serial data signal to a mission-environment receiver corresponding to the mission-environment transmitter;
substantially simultaneously with said transmitting of the received high-speed serial signal, digitizing the received high-speed serial signal to generate a first digitized signal; and
analyzing the first digitized signal.

32. A method according to claim 31, wherein said transmitting of the received high-speed serial data signal includes injecting jitter into the received high-speed serial data signal.

33. A method according to claim 32, further comprising verifying functional operation of the mission-environment transmitter and the mission-environment receiver so as to check tolerance to the jitter injected.

34. A method according to claim 31, wherein said transmitting of the received high-speed serial data signal includes voltage-swing controlling of the received high-speed serial data signal.

35. A method according to claim 34, further comprising verifying functional operation of the mission-environment transmitter and the mission-environment receiver so as to check tolerance to the voltage swing controlling.

36. A method according to claim 31, further comprising, between said receiving and said transmitting, deserializing and then serializing the received high-speed serial data signal.

37. A method according to claim 31, wherein said receiving of the high-speed serial data signal includes recovering a clock from the high-speed serial data signal.

38. A method according to claim 37, further comprising clocking said digitizing of the received high-speed serial data signal as a function of the clock recovered.

39. A method according to claim 31, wherein said digitizing of the received high-speed serial data signal includes digitizing the received high-speed serial data signal as a function of an external clock.

40. A method according to claim 31, further comprising digitizing the received high-speed serial data signal using a time-base generator so as to generate a second digitized signal and comparing the first digitized signal and the second digitized signal with one another.

41. A method according to claim 31, further comprising amplifying and conditioning the received high-speed serial data signal prior to said transmitting and said digitizing.

42. A method according to claim 31, wherein said analyzing of the first digitized signal is performed on an inline tester that also performed said receiving, said transmitting and said digitizing.

43. A method according to claim 31, wherein said analyzing of the first digitized signal includes generating an eye diagram.

44. A method according to claim 31, wherein said analyzing of the first digitized signal includes performing a bit-error-rate analysis.

45. A method according to claim 44 wherein said performing of the bit-error-rate analysis is performed as a function of a sampling point offset.

46. A method according to claim 31, further comprising deserializing the received high-speed serial data signal and analyzing the received high-speed serial data signal as a function of the deserialized received high-speed serial data signal.

47. A method of testing a high-speed serial link between a mission-environment transmitter and a mission-environment receiver, comprising:
providing a physical-layer tester that includes:
a high-speed data input for receiving high-speed serial data output by a mission-environment transmitter;
a high-speed data output for providing the high-speed serial data to a mission-environment receiver;
a data path extending between said high-speed data input and said high-speed data output for carrying the high-speed serial data from said high-speed data input to said high-speed data output without loss; and
a measurement path, in communication with said high-speed data input, for use in determining characteristics of the high-speed serial data;
placing said high-speed data input into communication with a first device having a mission-environment transmitter;
placing said high-speed data output into communication with a second device having a mission-environment receiver corresponding to the mission-environment transmitter; and
conducting testing of the high-speed serial link between the mission-environment transmitter and the mission-environment receiver.

48. A method according to claim 47, further comprising placing said physical-layer tester into communication with an external device that provides a user interface for said physical-layer tester.

49. A method according to claim 47, further comprising causing said physical-layer tester to inject jitter into the high-speed serial data received from the mission-environment transmitter.

50. A method according to claim 47, wherein said conducting of said testing includes conducting testing on mission-environment high-speed serial data.

51. A method according to claim 47, wherein said conducting of said testing includes causing said physical-layer tester to generate an eye diagram.

52. A method according to claim 47, wherein said conducting of said testing includes causing said physical-layer tester to conduct bit-error-rate testing.

53. A method according to claim 47, wherein said placing of said high-speed data input into communication with the first device includes connecting said high-speed data input to a motherboard and said placing of said high-speed data output into communication with the second device includes connecting said high-speed data input to a peripheral board.

54. A method according to claim 47, wherein said placing of said high-speed data input into communication with the first device includes connecting said high-speed data input to a high-speed data storage device.
